(19) United States
(12) Patent Application Publication
(10) Pub. No.: US 2021/0242748 A1
(43) Pub. Date: Aug. 5, 2021

(54) VARIABLE PITCH HELICAL COOLING JACKET

(71) Applicant: NIO USA, Inc., San Jose, CA (US)

(72) Inventors: Ming Fung Wong, San Jose, CA (US); Dimitri Bassis, Union City, CA (US)

(21) Appl. No.: 16/779,822

(22) Filed: Feb. 3, 2020

(51) Int. Cl. H02K 5/20; F28D 7/02; H02K 9/19

(52) U.S. Cl. CPC H02K 5/20; H02K 9/19; F28D 7/024

(57) ABSTRACT

Methods and systems are provided for cooling an electric motor. In embodiments, the cooling jacket includes a helical channel having a coolant inlet and a coolant outlet. The pitch of the helical channel decreases along an axial dimension of the helical channel, such that the pitch, and thus the cross-sectional area available for flow of the coolant, is greatest at or near the coolant inlet and smallest at or near the coolant outlet. The cooling jacket also includes flow-through loops associated with the first and final turns of the helical channel to allow coolant to circulate about entry and exit portions of the motor multiple times.

### FIELD

This disclosure relates generally to cooling jackets for electrical motors, and particularly to helical cooling jackets with a variable pitch to improve cooling performance and ensure a more uniform spatial distribution of temperature.

### BACKGROUND

The performance and lifespan of permanent magnet (PM) electric motors are sensitive to operating temperatures on or within the copper coil, the magnet, and the shaft. As a result, water, because of its high heat capacity (and thus its effectiveness at carrying away heat when present even in relatively small amounts), is commonly used as a coolant for PM motors. Water cooling is thus the primary method for cooling motors in, by way of non-limiting example, electric vehicles (EVs), because weight, dimension, and efficiency are key to successful powertrain design.

To date, the most common approaches to water cooling of electrical motors employ a cooling “jacket” comprising either inline water channels or helical channels. In helical designs, coolant enters the jacket from one end of the helical channel, loops around the cylindrical face of the electric motor to carry heat away from the motor housing, and exits from the other end of the helical channel at an opposite end of the motor housing. Such designs suffer from at least two drawbacks: first, as the coolant draws heat away from the surface of the motor, the temperature of the coolant increases and the coolant effectiveness concomitantly decreases along the length of the helical channel from the entrance to the exit, and second, the ramp-in and ramp-out sections of the water inlet and outlet are generally characterized by poor coolant flow and thus a “blind spot” in the cooling jacket.

There is, thus, a need in the art for cooling jackets for electric motors that maintain the effectiveness of the coolant along the length of the cooling jacket channels and mitigate or eliminate blind spots in the cooling effectiveness.

### SUMMARY

Embodiments of the present disclosure include a cooling jacket for an electric motor, comprising a coolant inlet; a coolant outlet; a helical channel, interconnecting and providing a coolant flow path between the coolant inlet and the coolant outlet, and defining and surrounding an annular space adapted to receive the electric motor or a portion thereof; a first flow-through loop, positioned proximate to and in fluid communication with the coolant inlet and a first turn of the helical channel, whereby coolant entering the helical channel via the coolant inlet may flow through the first flow-through loop before flowing into subsequent turns of the helical channel; and a second flow-through loop, positioned proximate to and in fluid communication with the coolant outlet and a final turn of the helical channel, whereby coolant received from preceding turns of the helical channel may flow through the second flow-through loop before exiting the helical channel via the coolant outlet, wherein a pitch of the helical channel monotonically decreases along an axis of the helical channel such that the pitch is greatest at the first turn of the helical channel and smallest at the final turn of the helical channel.

Aspects of the above cooling jacket include cooling jackets wherein a radial width of the helical channel is substantially constant.

Aspects of the above cooling jacket include cooling jackets wherein the annular space is adapted to receive a stator of the electric motor, wherein an axial length of the cooling jacket is approximately equal to a length of the stator. When the stator is positioned within the annular space, substantially all of an outer surface of the stator may, but need not, be surrounded by the helical channel.

Aspects of the above cooling jacket include cooling jackets wherein the helical channel comprises no more than five turns.

Aspects of the above cooling jacket include cooling jackets wherein the coolant inlet and the coolant outlet are circumferentially offset by between about 0° and about 180°. The coolant inlet and the coolant outlet may, but need not, be circumferentially offset by between about 45° and about 135°.

Aspects of the above cooling jacket include cooling jackets wherein the coolant is water.

Aspects of the above cooling jacket include cooling jackets wherein a cross-sectional area of the helical channel monotonically decreases along the helical channel such that the cross-sectional area is greatest at the coolant inlet and smallest at the coolant outlet.

Embodiments of the present disclosure include a method for cooling an electric motor or a portion thereof, comprising providing a coolant into a helical channel of a cooling jacket via a coolant inlet; passing the coolant through the helical channel; and withdrawing the coolant from the helical channel via a coolant outlet, wherein the cooling jacket comprises a first flow-through loop, positioned proximate to and in fluid communication with the coolant inlet and a first turn of the helical channel, whereby coolant entering the helical channel via the coolant inlet may flow through the first flow-through loop before flowing into subsequent turns of the helical channel, wherein the cooling jacket further comprises a second flow-through loop, positioned proximate to and in fluid communication with the coolant outlet and a final turn of the helical channel, whereby coolant received from preceding turns of the helical channel may flow through the second flow-through loop before exiting the helical channel via the coolant outlet, and wherein a pitch of the helical channel monotonically decreases along an axis of the helical channel such that the pitch is greatest at the first turn of the helical channel and smallest at the final turn of the helical channel.

Aspects of the above method include methods wherein a radial width of the helical channel is substantially constant.

Aspects of the above method include methods wherein the helical channel defines and surrounds an annular space adapted to receive the electric motor or a portion thereof, wherein a stator is at least partially disposed within the annular space and surrounded by the helical channel, wherein an axial length of the cooling jacket is approximately equal to a length of the stator. Substantially all of an outer surface of the stator may, but need not, be surrounded by the helical channel.

Aspects of the above method include methods wherein the helical channel comprises no more than five turns.

Aspects of the above method include methods wherein the cooling inlet and the cooling outlet are circumferentially offset by between about 0° and about 180°. The cooling inlet and the cooling outlet may, but need not, be circumferentially offset by between about 45° and about 135°.

Aspects of the above method include methods wherein the coolant is water.

Aspects of the above method include methods wherein a cross-sectional area of the helical channel monotonically decreases along the helical channel such that the cross-sectional area is greatest at the coolant inlet and smallest at the coolant outlet.

Embodiments of the present disclosure include an electric motor, comprising a stator; and a cooling jacket extending over at least part of the stator, comprising a coolant inlet; a coolant outlet; a helical channel, interconnecting and providing a coolant flow path between the coolant inlet and the coolant outlet; a first flow-through loop, positioned proximate to and in fluid communication with the coolant inlet and a first turn of the helical channel, whereby coolant entering the helical channel via the coolant inlet may flow through the first flow-through loop before flowing into subsequent turns of the helical channel; and a second flow-through loop, positioned proximate to and in fluid communication with the coolant outlet and a final turn of the helical channel, whereby coolant received from preceding turns of the helical channel may flow through the second flow-through loop before exiting the helical channel via the coolant outlet, wherein a pitch of the helical channel monotonically decreases along an axis of the helical channel such that the pitch is greatest at the first turn of the helical channel and smallest at the final turn of the helical channel.

Aspects of the above electric motor include electric motors wherein a radial width of the helical channel is substantially constant.

For purposes of further disclosure and to comply with applicable written description and enablement requirements, the following references are incorporated herein by reference in their entireties:

U.S. Pat. No. 7,745,965, entitled “Electrical machine having a cooling jacket,” issued 29 Jun. 2010 to Oestreich (“Oestreich”).

PCT Application Publication 2012/156104, entitled “Cooling jacket for electric motors,” published 22 Nov. 2012 to Schubert et al. (“Schubert”).

PCT Application Publication 2013/041047, entitled “Electrical motor water cooling device,” published 28 Mar. 2013 to Xiao et al. (“Xiao”).

### BRIEF DESCRIPTION OF THE DRAWINGS

FIG. 1 illustrates a variable pitch helical cooling jacket in accordance with embodiments of the present disclosure; and

FIG. 2 shows a variable pitch helical cooling jacket having flow-through loops in accordance with embodiments of the present disclosure.

### DETAILED DESCRIPTION

As used herein, unless otherwise specified, the term “pitch” refers to the height of a complete turn of a helix, measured parallel to the axis of the helix.

The present disclosure improves the cooling capacity of a cooling jacket by varying the pitch of a helical channel of the cooling jacket along the axis of the helical channel. More specifically, the pitch of helical channels of cooling jackets of the present disclosure is greatest at or near a coolant inlet of the helical channel and monotonically decreases along the axis of the helical channel until the pitch reaches a minimum at or near a coolant outlet of the helical channel. As a result of this variable pitch of the helical channel, the cross-sectional area of the helical channel monotonically decreases, and therefore the linear and/or rotational flow rate of the coolant through the helical channel monotonically increases, from the coolant inlet to the coolant outlet. The radial dimension of the helical channel may be constant, but may also decrease, or may even increase so long as the increase in the radial dimension is proportionally less than the decrease in the pitch, thereby ensuring that the cross-sectional area of the helical channel monotonically decreases from the coolant inlet to the coolant outlet. Thus, even though the temperature of the coolant (e.g. water) increases as the coolant flows from the coolant inlet toward the coolant outlet, the increase in linear and/or rotational flow rate balances or compensates for the warming of the coolant and provides a more balanced or uniform cooling effectiveness along the entirety of the axis of the helical channel, and therefore about an entire surface of a housing (or part thereof) of an electric motor disposed within the cooling jacket. In other words, the cooling effectiveness of cooling jackets of the present disclosure is substantially uniform, both axially and radially.

The present disclosure still further improves the cooling capacity of a cooling jacket by providing flow-through loops at or near both the coolant inlet and the coolant outlet of a helical channel of the cooling jacket. In the cooling jackets of the prior art, the “ramp-in” and “ramp-out” sections of the helical channel at or near the coolant inlet and the coolant outlet are often characterized by impaired or ineffective flow, which results in cooling “blind spots” and thus “hot spots” on the surface of a housing of an electric motor, i.e. localized areas of ineffective cooling and therefore greater temperature. The flow-through loops of the present disclosure address this issue by allowing for a volume of coolant to circulate about both an inlet end and an outlet end of the cooling jacket multiple times, thus improving the cooling effectiveness of the cooling jacket in these areas and eliminating “blind spots” and/or “hot spots.” The flow-through loops generally take the form of circular loops with a substantially constant position along the axis of the helical channel. More specifically, a first turn of the helical channel is bifurcated into a main channel and a flow-through loop, such that a volume of coolant (e.g. water), upon entering the helical channel via the coolant inlet, may either flow directly along the main channel and thus through succeeding turns of the helical channel along the axis of the helical channel, or circulate through the flow-through loop one or more times before entering the main channel. In this way, at least a portion of the coolant provided to the cooling jacket circulates about an inlet end of the surface of the housing (or part thereof) of the electric motor disposed within the cooling jacket multiple times, thus compensating for any impairment or ineffectiveness of coolant flow and eliminating the “blind spot” or “hot spot.” The same feature is provided, mutatis mutandis, in association with a final turn of the helical channel, such that a volume of coolant may circulate about an outlet end of the housing (or part thereof) multiple times before exiting the cooling jacket.

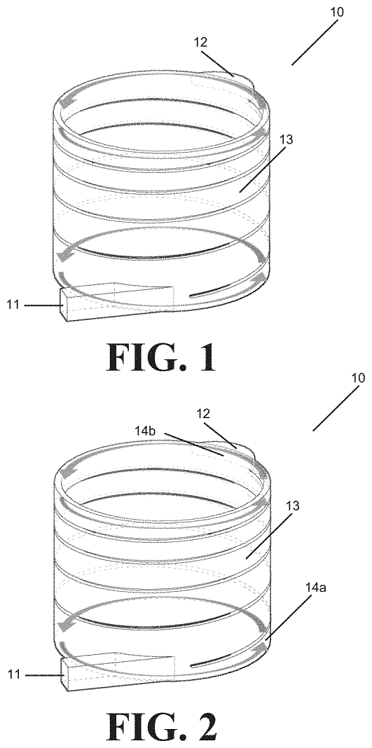

Referring now to FIG. 1, a first embodiment of a cooling jacket 1, within which an electric motor or a part thereof can be disposed, is illustrated. The cooling jacket 1 comprises a coolant inlet 11 and a coolant outlet 12 interconnected via a helical channel 13. The pitch and therefore the cross-sectional area, i.e. a coolant flow cross-section, of the helical channel 13 are largest at the coolant inlet 11 and smallest at the coolant outlet 12, and the temperature of the coolant is lowest at the coolant inlet 11 and increases along the length of the helical channel 13 to the same extent that the width of the coolant flow cross-section increases. Due to the decreasing axial width of the helical channel 13, the change in the temperature gradient between the coolant and the housing of the motor—which is greater at the coolant inlet 11 and smallest at the coolant outlet 12—can be compensated for, because the linear or rotational velocity of the coolant increases as it travels along helical channel 13.

The change in the pitch of the helical channel 13 provides an additional advantage, namely that the required hydraulic pressure or power of the coolant can be decreased relative to cooling jackets of the prior art. This advantage can be achieved because the pressure drop or loss within the helical channel 13 is minimized as a result of the change in helical pitch.

Referring now to FIG. 2, a second embodiment of a cooling jacket 1 is illustrated. In this embodiment, the cooling jacket is provided with flow-through loops 14a,b associated with a first turn (i.e. a “ramp-in” portion) and a final turn (i.e. a “ramp-out” portion) of the helical channel 13, respectively. The flow-through loops 14a,b address a particular drawback of many of the cooling jackets known and used in the art: uncooled areas of the housing of the electric motor (or part thereof) disposed within the jacket. Particularly when the number of helical turns is limited (e.g. less than about five), the inlet and outlet portions of the helical channels of conventional cooling jackets will generally “leave behind” (i.e. leave uncovered by the jacket and thus uncooled) an area of the housing having an axial width equal to the pitch of the helix and a circumferential length equal to roughly half a turn (i.e. 180 degrees) of the helix. The only way prior cooling jackets can address this problem is to increase the length of the motor housing itself to allow for an increase in the length of the cooling jacket, which of course can have many drawbacks, including but not limited to increased weight and decreased available space for other motor components and systems.

As illustrated in FIGS. 1 and 2, the present disclosure solves the problem of the areas of the housing “left behind” by short (less than five turns) cooling jackets of the prior art by providing flow-through loops 14a,b (the arrows represent circumferential flow of coolant through the flow-through loops). By allowing at least a portion of the coolant to circulate about a circumference of the housing multiple times near the coolant inlet 11 and coolant outlet 12, the cooling jacket 10 of the present disclosure reduces the number of turns of the helical channel 13 needed for adequate cooling, which in turn allows for the overall length of the cooling jacket 10 to be shortened. Preferably, the cooling jacket 10 of the present disclosure may be no longer than a stator and/or stator winding of the electric motor to be cooled, thus decreasing the material requirements and overall dimension of the assembly, while simultaneously avoiding the creation of “blind spots” or “hot spots” near the cooling inlet 11 and cooling outlet 12 (i.e. the entrance and exit of the helical channel 13). This feature is particularly advantageous when the motor to be cooled is a short or “pancake-shaped” motor, i.e. where the length and/or volume available for the cooling jacket may be severely limited and thus the number of turns of the helical channel 13 must be absolutely minimized; in these embodiments, cooling jackets 10 may represent the only viable cooling option.

Another advantage provided by flow-through loops 14a,b of the cooling jacket 10 of the present disclosure is that it allows the cooling jacket 10 to be constructed in a much greater variety of configurations, specifically with regard to the circumferential positions of the coolant inlet 11 and coolant outlet 12. Helical cooling jackets that have been previously known and described often require that a coolant inlet and coolant outlet be placed at the same, or very nearly the same, circumferential point on the jacket and/or motor housing, and thus that the directions of coolant flow at the inlet and outlet of the cooling jacket be substantially parallel to each other; in many cases, this is an inefficient use of space in the motor compartment and can cause the displacement of other components. The present disclosure, by contrast, allows for many different circumferential positions of the coolant inlet 11 and coolant outlet 12 relative to each other, and so can be adapted to many desired geometries; by way of non-limiting example, the coolant inlet 11 and coolant outlet 12 of the cooling jacket 10 illustrated in FIGS. 1 and 2 are circumferentially offset by approximately 90° (and, thus, the directions of flow of the coolant at the inlet and outlet are offset by the same amount), which may permit, e.g., coolant lines to be more advantageously positioned relative to the cooling jacket 10, the motor, or other components.

The cooling jacket 10 of the present disclosure provides the foregoing advantages and benefits at a minimum of cost, materials, and complexity. Previous attempts to address the drawbacks of the prior art identified herein have, in many cases, required more complicated constructions of the cooling jacket, particularly the provision of multiple coolant channels running counter-current or cross-current to each other. Although such designs may, in some cases, mitigate or eliminate “blind spots” or “hot spots” on the surface of the motor housing, they generally extend the length of the cooling jacket beyond the length of the stator and/or require very precise positioning of the various coolant inlets and outlets. The simple design of the cooling jacket 10 of the present disclosure eliminates the need for counter-current or cross-current coolant flows; instead, it allows for uniform cooling using just a single coolant flow path, and does so with a minimum of materials and while taking up minimal space in the motor compartment.

In embodiments, when cooling jackets according to the present disclosure, such as cooling jackets as illustrated by FIGS. 1 and 2, are in use, a coolant, e.g. water, enters the helical channel of the cooling jacket via the coolant inlet, loops around a cylindrical face of the electric motor or a part thereof to carry heat away from a housing of the motor, and exits the helical channel from an axially opposed end of the housing via the coolant outlet. As the coolant picks up heat from the surface of the electric motor along the helical channel before exiting via the coolant outlet, the temperature of the coolant increases, which in cooling jackets of the prior art causes the cooling effectiveness of the coolant to decrease. In the practice of the present disclosure, however, a cross-sectional area of the helical jacket, and thus a cross-sectional area available for flow of the coolant, monotonically decreases along the length of the helical channel, such that a linear or rotational velocity of the coolant increases along the length of the helical channel; this increase in the velocity of the coolant compensates for the increase in the temperature of the coolant and allows for the effectiveness of the coolant to be substantially uniform, both axially and radially, about an entire surface of the motor housing. Additionally, cooling jackets according to the present disclosure eliminate or mitigate “blind spots” or “hot spots,” i.e. portions of the motor housing that are not effectively cooled and thus have a locally higher temperature, at or near the coolant inlet and/or the coolant outlet by (1) providing substantially complete coverage of the entire surface of the motor housing, rectifying the areas “left behind” by cooling jackets of the prior art (especially those having a relatively short axial dimension), and (2) providing flow-through loops in association with the first and final turns of the helical channel, allowing coolant to circulate about corresponding portions of the motor housing multiple times.

Any of the steps, functions, and operations discussed herein can be performed continuously and automatically.

To avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments of the present disclosure include a cooling jacket for an electric motor, comprising a coolant inlet; a coolant outlet; a helical channel, interconnecting and providing a coolant flow path between the coolant inlet and the coolant outlet, and defining and surrounding an annular space adapted to receive the electric motor or a portion thereof; a first flow-through loop, positioned proximate to and in fluid communication with the coolant inlet and a first turn of the helical channel, whereby coolant entering the helical channel via the coolant inlet may flow through the first flow-through loop before flowing into subsequent turns of the helical channel; and a second flow-through loop, positioned proximate to and in fluid communication with the coolant outlet and a final turn of the helical channel, whereby coolant received from preceding turns of the helical channel may flow through the second flow-through loop before exiting the helical channel via the coolant outlet, wherein a pitch of the helical channel monotonically decreases along an axis of the helical channel such that the pitch is greatest at the first turn of the helical channel and smallest at the final turn of the helical channel.

Aspects of the above cooling jacket include cooling jackets wherein a radial width of the helical channel is substantially constant.

Aspects of the above cooling jacket include cooling jackets wherein the annular space is adapted to receive a stator of the electric motor, wherein an axial length of the cooling jacket is approximately equal to a length of the stator. When the stator is positioned within the annular space, substantially all of an outer surface of the stator may, but need not, be surrounded by the helical channel.

Aspects of the above cooling jacket include cooling jackets wherein the helical channel comprises no more than five turns.

Aspects of the above cooling jacket include cooling jackets wherein the coolant inlet and the coolant outlet are circumferentially offset by between about 0° and about 180°. The coolant inlet and the coolant outlet may, but need not, be circumferentially offset by between about 45° and about 135°.

Aspects of the above cooling jacket including cooling jackets wherein the coolant is water.

Aspects of the above cooling jacket include cooling jackets wherein a cross-sectional area of the helical channel monotonically decreases along the helical channel such that the cross-sectional area is greatest at the coolant inlet and smallest at the coolant outlet.

Embodiments of the present disclosure include a method for cooling an electric motor or a portion thereof, comprising providing a coolant into a helical channel of a cooling jacket via a coolant inlet; passing the coolant through the helical channel; and withdrawing the coolant from the helical channel via a coolant outlet, wherein the cooling jacket comprises a first flow-through loop, positioned proximate to and in fluid communication with the coolant inlet and a first turn of the helical channel, whereby coolant entering the helical channel via the coolant inlet may flow through the first flow-through loop before flowing into subsequent turns of the helical channel, wherein the cooling jacket further comprises a second flow-through loop, positioned proximate to and in fluid communication with the coolant outlet and a final turn of the helical channel, whereby coolant received from preceding turns of the helical channel may flow through the second flow-through loop before exiting the helical channel via the coolant outlet, and wherein a pitch of the helical channel monotonically decreases along an axis of the helical channel such that the pitch is greatest at the first turn of the helical channel and smallest at the final turn of the helical channel.

Aspects of the above method include methods wherein a radial width of the helical channel is substantially constant.

Aspects of the above method include methods wherein the helical channel defines and surrounds an annular space adapted to receive the electric motor or a portion thereof, wherein a stator is at least partially disposed within the annular space and surrounded by the helical channel, wherein an axial length of the cooling jacket is approximately equal to a length of the stator. Substantially all of an outer surface of the stator may, but need not, be surrounded by the helical channel.

Aspects of the above method include methods wherein the helical channel comprises no more than five turns.

Aspects of the above method include methods wherein the cooling inlet and the cooling outlet are circumferentially offset by between about 0° and about 180°. The cooling inlet and the cooling outlet may, but need not, be circumferentially offset by between about 45° and about 135°.

Aspects of the above method include methods wherein the coolant is water.

Aspects of the above method include methods wherein a cross-sectional area of the helical channel monotonically decreases along the helical channel such that the cross-sectional area is greatest at the coolant inlet and smallest at the coolant outlet.

Embodiments of the present disclosure include an electric motor, comprising a stator; and a cooling jacket extending over at least part of the stator, comprising a coolant inlet; a coolant outlet; a helical channel, interconnecting and providing a coolant flow path between the coolant inlet and the coolant outlet; a first flow-through loop, positioned proximate to and in fluid communication with the coolant inlet and a first turn of the helical channel, whereby coolant entering the helical channel via the coolant inlet may flow through the first flow-through loop before flowing into subsequent turns of the helical channel; and a second flow-through loop, positioned proximate to and in fluid communication with the coolant outlet and a final turn of the helical channel, whereby coolant received from preceding turns of the helical channel may flow through the second flow-through loop before exiting the helical channel via the coolant outlet, wherein a pitch of the helical channel monotonically decreases along an axis of the helical channel such that the pitch is greatest at the first turn of the helical channel and smallest at the final turn of the helical channel.

Aspects of the above electric motor include electric motors wherein a radial width of the helical channel is substantially constant.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

What is claimed is:

1. A cooling jacket for an electric motor, comprising:
a coolant inlet;
a coolant outlet;
a helical channel, interconnecting and providing a coolant flow path between the coolant inlet and the coolant outlet, and defining and surrounding an annular space adapted to receive the electric motor or a portion thereof;
a first flow-through loop, positioned proximate to and in fluid communication with the coolant inlet and a first turn of the helical channel, whereby coolant entering the helical channel via the coolant inlet may flow through the first flow-through loop before flowing into subsequent turns of the helical channel; and
a second flow-through loop, positioned proximate to and in fluid communication with the coolant outlet and a final turn of the helical channel, whereby coolant received from preceding turns of the helical channel may flow through the second flow-through loop before exiting the helical channel via the coolant outlet,
wherein a pitch of the helical channel substantially monotonically decreases along an axis of the helical channel such that the pitch is greatest at the first turn of the helical channel and smallest at the final turn of the helical channel.

2. The cooling jacket of claim 1, wherein a radial width of the helical channel is substantially constant.

3. The cooling jacket of claim 1, wherein the annular space is adapted to receive a stator of the electric motor, wherein an axial length of the cooling jacket is approximately equal to a length of the stator.

4. The cooling jacket of claim 3, wherein, when the stator is positioned within the annular space, substantially all of an outer surface of the stator is surrounded by the helical channel.

5. The cooling jacket of claim 1, wherein the helical channel comprises no more than five turns.

6. The cooling jacket of claim 1, wherein the coolant inlet and the coolant outlet are circumferentially offset by between about 0° and about 180°.

7. The cooling jacket of claim 6, wherein the coolant inlet and the coolant outlet are circumferentially offset by between about 45° and about 135°.

8. The cooling jacket of claim 1, wherein the coolant is water.

9. The cooling jacket of claim 1, wherein a cross-sectional area of the helical channel monotonically decreases along the helical channel such that the cross-sectional area is greatest at the coolant inlet and smallest at the coolant outlet.

10. A method for cooling an electric motor or a portion thereof, comprising:
providing a coolant into a helical channel of a cooling jacket via a coolant inlet;
passing the coolant through the helical channel; and
withdrawing the coolant from the helical channel via a coolant outlet,
wherein the cooling jacket comprises a first flow-through loop, positioned proximate to and in fluid communication with the coolant inlet and a first turn of the helical channel, whereby coolant entering the helical channel via the coolant inlet may flow through the first flow-through loop before flowing into subsequent turns of the helical channel,
wherein the cooling jacket further comprises a second flow-through loop, positioned proximate to and in fluid communication with the coolant outlet and a final turn of the helical channel, whereby coolant received from preceding turns of the helical channel may flow through the second flow-through loop before exiting the helical channel via the coolant outlet, and
wherein a pitch of the helical channel substantially monotonically decreases along an axis of the helical channel such that the pitch is greatest at the first turn of the helical channel and smallest at the final turn of the helical channel.

11. The method of claim 10, wherein a radial width of the helical channel is substantially constant.

12. The method of claim 10, wherein the helical channel defines and surrounds an annular space adapted to receive the electric motor or a portion thereof, wherein a stator is at least partially disposed within the annular space and surrounded by the helical channel, wherein an axial length of the cooling jacket is approximately equal to a length of the stator.

13. The method of claim 12, wherein substantially all of an outer surface of the stator is surrounded by the helical channel.

14. The method of claim 10, wherein the helical channel comprises no more than five turns.

15. The method of claim 10, wherein the cooling inlet and the cooling outlet are circumferentially offset by between about 0° and about 180°.

16. The method of claim 15, wherein the cooling inlet and the cooling outlet are circumferentially offset by between about 45° and about 135°.

17. The method of claim 10, wherein the coolant is water.

18. The method of claim 10, wherein a cross-sectional area of the helical channel monotonically decreases along the helical channel such that the cross-sectional area is greatest at the coolant inlet and smallest at the coolant outlet.

19. An electric motor, comprising:
a stator; and
a cooling jacket extending over at least part of the stator, comprising:
a coolant inlet;
a coolant outlet;
a helical channel, interconnecting and providing a coolant flow path between the coolant inlet and the coolant outlet;
a first flow-through loop, positioned proximate to and in fluid communication with the coolant inlet and a first turn of the helical channel, whereby coolant entering the helical channel via the coolant inlet may flow through the first flow-through loop before flowing into subsequent turns of the helical channel; and
a second flow-through loop, positioned proximate to and in fluid communication with the coolant outlet and a final turn of the helical channel, whereby coolant received from preceding turns of the helical channel may flow through the second flow-through loop before exiting the helical channel via the coolant outlet,
wherein a pitch of the helical channel substantially monotonically decreases along an axis of the helical channel such that the pitch is greatest at the first turn of the helical channel and smallest at the final turn of the helical channel.

20. The electric motor of claim 19, wherein a radial width of the helical channel is substantially constant.
